(19) United States
(12) Patent Application Publication
(10) Pub. No.: US 2015/0015547 A1
(43) Pub. Date: Jan. 15, 2015

(54) PASSIVE STYLUS

(71) Applicant: CHIA-CHING LIN, TAIPEI CITY (TW)

(72) Inventor: CHIA-CHING LIN, TAIPEI CITY (TW)

(21) Appl. No.: 13/939,304

(22) Filed: Jul. 11, 2013

(51) Int. Cl. G06F 3/0354

(52) U.S. Cl. CPC G06F 3/03545
USPC 345/179

(57) ABSTRACT

A passive stylus includes a conductive body and a power supply. The conductive body has portions defining a receiving chamber therein. One end of the conductive body has a touch-control portion disposed thereon. The power supply includes a battery unit disposing in the receiving chamber of the conductive body. One power connector is electrically connected to the battery unit. When one electronic device is connected to the power connector, the battery unit electrically charges the electronic device.

### BACKGROUND OF THE INVENTION

1. Field of the Invention

The instant disclosure relates to a stylus; in particular, to a passive stylus.

2. Description of Related Art

The control of electronic devices is revolutionized with the invention of touch screen. User input commands no longer require keyboards and mouses, and may be directly input commands by swiping and drawing on the touch screen. Among the various types of touch screens, capacitive touch screen is relatively durable, and due to that reason, it has been widely applied to electronic devices such as cellphones, tablet PCs, and etc. In order to enhance convenience for user control, most of the touch panels are paired with a stylus for point contact input, or writing or drawing input commands on the touch panel. Generally, there are two types of stylus. One type is a passive stylus which is based on the principle of conductance. Harnessing the weak leakage current within the human body that flows through the stylus, the electric potential of the capacitance on the surface of the touch panel or the electric field of the projected capacitance are modified. The other type is an active stylus which can be inherently designed with an inductive electric field. The active stylus modifies the electric field of the projected capacitance or modifies the electric potential of the surface capacitance via the built-in capacitor and discharge circuitry.

However, the passive and active styluses have some shortcomings. For example, active stylus requires additional circuitry and corresponding power supply which complicates the internal configuration within the stylus conductive body. Moreover, the production cost is relatively high. Since passive stylus does not require internal circuits, the stylus conductive body is hollow which is a waste of free space.

Moreover, since more emphasis is put on quick and user-friendly applications of electronic devices such as smart phones, tablet PCs, and etc., more high-end processors and sensors are designed into the electronic devices, which consume a lot of power during operation and leads to the constant need to recharge battery power. For outdoor users, the lack of instant power supply is especially inconvenient when power of the electronic device is depleted. As a result, manufacturers recently develop portable power supply for users to directly charge anytime via connection cables. Outdoor users tend to separately carry portable power supply and stylus for smart phones, tablet PCs, or similar products, which causes inconvenience for users.

To address the above issues, the inventor strives via associated experience and research to present the instant disclosure, which can effectively improve the limitation described above.

### SUMMARY OF THE INVENTION

The object of the instant disclosure is to provide a passive stylus which includes a conductive body and a power supply. The conductive body has a tubular structure and portions defining a receiving chamber therein. One end of the conductive body has a touch-control portion. The power supply includes a battery unit disposed in the receiving chamber of the conductive body. A power connector is connected to the battery unit. When the power connector is connected to an electronic device, the battery unit electrically charges the electronic device.

Furthermore, when the power connector is connected to an external power supply, the external power supply charges the battery unit. The power connector can include at least one USB (universal serial bus), through which the electronic device or the external power supply is connected, for charging purposes. The power connector can also include a control unit and at least one indicator. The indicator controls and displays the charging and discharging status of the power supply. The touch-control portion can be at least one of the following: a conductive gel, foam, polymer, or metallic body.

Moreover, the instant disclosure also provides a passive stylus which includes a conductive body, a touch-control portion, and a power supply. The conductive body has a tubular structure and portions defining a receiving chamber therein. One end of the conductive body has a touch-control portion arranged thereon. The touch-control portion is a conductive structure which is electrically connected to the conductive body. The power supply includes a battery unit disposed in the receiving chamber of the conductive body. A power connector is connected to the battery unit. When the power connector is connected to an electronic device, the battery unit electrically charges the electronic device.

Furthermore, when the power connector is connected to an external power supply, the external power supply charges the battery unit. The power connector can include at least one USB (universal serial bus) or other types of electrical connectors, through which the electronic device or the external power supply is connected, for charging purposes. Two USBs are applied herein, which can be respectively arranged on two ends of the conductive body. The touch-control portion can be a shell structure which can be press-fitted, bolted, coupled, or detachably attached to the conductive body. An end of the conductive body may have two USBs arranged thereon such that a connection cable has a two-sided USB which can be correspondingly inserted in the two USBs on the conductive body and can be stored in the shell structure.

The instant disclosure also provides a passive stylus, which includes a conductive body, a touch-control portion, a conductive element, and a power supply. The conductive body has a tubular structure and portions defining a receiving chamber therein. The conductive element is disposed in the receiving chamber. The touch-control portion is arranged at one end of the conductive body. The touch-control portion is a conductive structure which is electrically connected to the conductive body. The power supply includes at least one battery unit and one power connector. At least one battery unit is disposed in the receiving chamber of the conductive body. One end of the battery unit is electrically connected to one end of the conductive element. The power connector is electrically connected to the other end of the conductive element and the other end of the battery unit. When the power connector is connected to an electronic device, the battery unit electrically charges the electronic device. Furthermore, at least one battery unit can be a rechargeable battery. The power connector can detachably dispose at the other end of the conductive body.

The instant disclosure provides the following improvements. With the receiving chamber of the passive stylus, the power supply can be disposed in the receiving chamber such that the stylus can simultaneously operate touch-control commands and portably charges electronic devices. The instant disclosure also provides convenience to users by incorporating the portable power supply into the passive stylus.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of a passive stylus in accordance with a first embodiment of the instant disclosure;

FIG. 2 is an assembled view of the passive stylus in accordance with the first embodiment of the instant disclosure;

FIG. 3 is a perspective view illustrating the operation of the passive stylus in accordance with the instant disclosure;

FIG. 4 is a perspective view of the passive stylus in accordance with a second embodiment of the instant disclosure;

FIG. 5 is an exploded view of the passive stylus in accordance with a third embodiment of the instant disclosure;

FIG. 6 is a perspective view of the passive stylus in accordance with a fourth embodiment of the instant disclosure; and

FIG. 7 is an exploded view of the passive stylus in accordance with a fifth embodiment of the instant disclosure;

FIG. 8 is an assembled view of the passive stylus in accordance with the fifth embodiment of the instant disclosure;

FIG. 9 is an exploded view of the passive stylus in accordance with a sixth embodiment of the instant disclosure.

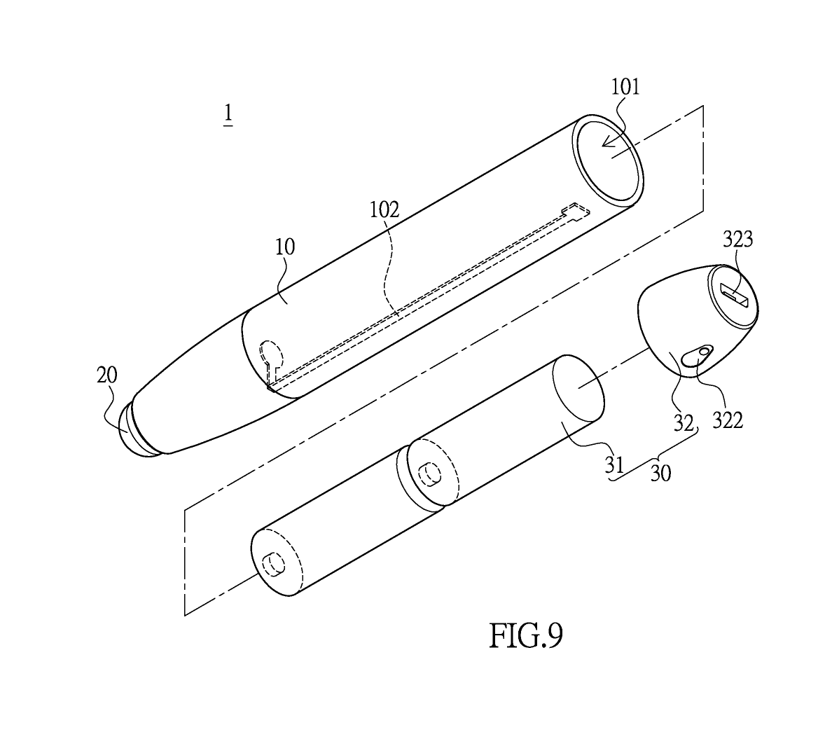

### DETAILED DESCRIPTION OF THE PREFERRED EMBODIMENTS

### First Embodiment

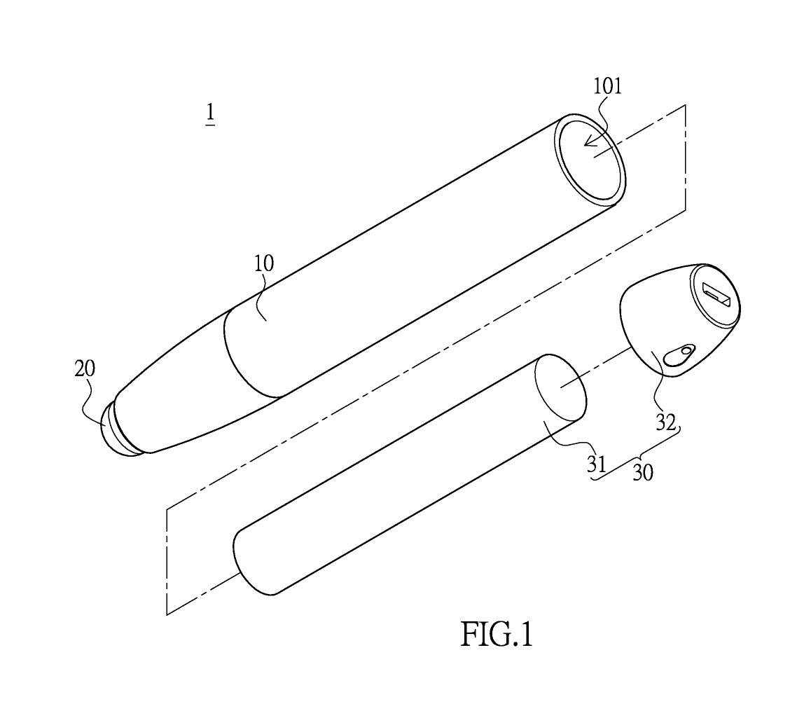

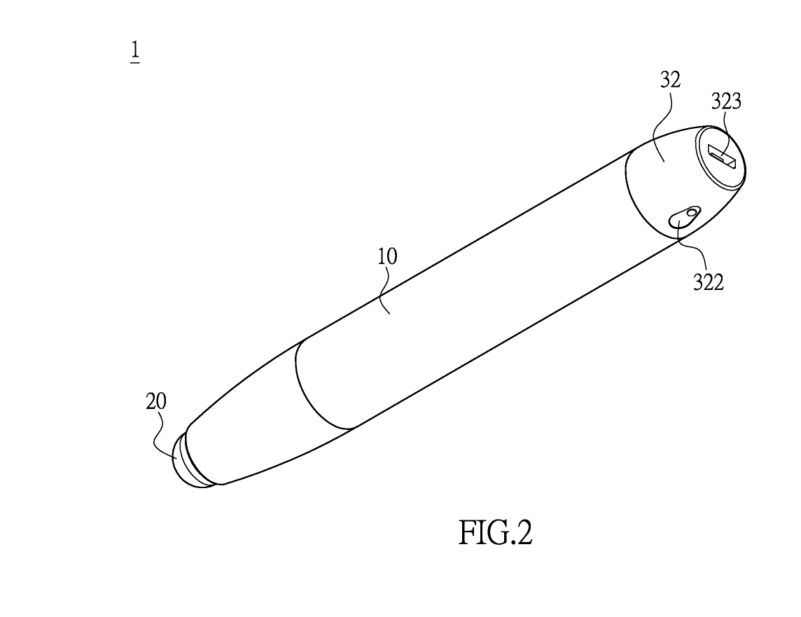

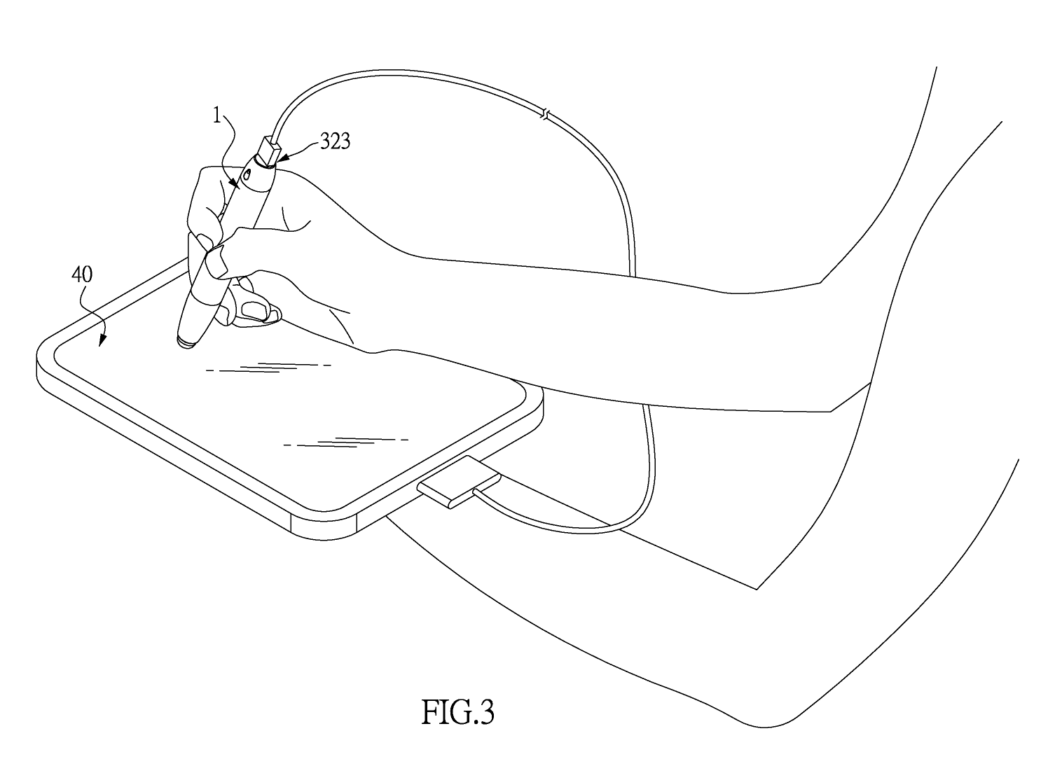

Please refer to FIGS. 1 through 3. FIG. 1 is an exploded view of a passive stylus in accordance with the first embodiment of the instant disclosure. FIG. 2 is an assembled view of the passive stylus in accordance with the first embodiment of the instant disclosure. FIG. 3 is a perspective view illustrating the operation of the passive stylus in accordance with the instant disclosure. As illustrated, the passive stylus includes a conductive body 10 and a power supply 30. The conductive body 10 has a tubular structure and portions defining a receiving chamber 101 therein. One end of the conductive body 10 has a touch-control portion 20. The touch-control portion 20 is preferably made of conductive gel, conductive foam, conductive polymer or metallic body. Notably, the outer surface of the conductive body 10, based on the demand of the design, can be arranged with a non-slip portion which substantially conforms to the hands of a pen holder, or a retaining element. In the instant embodiment, a smooth housing is illustrated, but is not limited hereto. The power supply 30 is disposed in the receiving chamber 101 of the conductive body 10. The power supply includes a battery unit 31 and a power connector 32. Specifically, the battery unit 31 can be lithium battery or any type of rechargeable battery. The power connector 32 is preferably a universal serial bus (USB) interface 323 as illustrated in FIG. 2. Namely, the USB interface 323 shown in FIG. 2 is only exemplary but it not limited hereto. Based on different charging and discharging needs, the power connector 32 can also has two USB interfaces 323. Specifically, when users hold the conductive body 10, particular points can be correspondingly chosen via the touch-control portion 20. Moreover, users can connect the stylus 1 to the electronic device 40 via the power connector 32 in order to recharge and discharge the electronic device 40. As mentioned above, the stylus 1 of the instant disclosure has a power supply 30 disposed in the receiving chamber 101 of the conductive body 10 in order to provide a stylus with a portable power source.

As shown in FIG. 3, a perspective view illustrates the operation of the passive stylus in accordance with the instant disclosure. Users can operate the electronic device 40 with the stylus 1 via touch control, and meanwhile electrically charge the electronic device 40 (such as smart phones or tablet PCs) via a transfer cable (such as a USB transfer cable). Notably, the aforementioned operation is only exemplary, the stylus 1 can operate independently as a stylus or independently as a portable power source. Moreover, in a preferred embodiment, the power connector 32 can be connected to an external power supply (not shown in figures, such as the common outlet or socket, or a computer USB plug) to electrically charge the battery unit 31.

Notably, the power connector 32 can also include an indicator 322. Users can understand the charging and discharging status of the power supply 30 via the indicator 322 (for example, the indicator 322 can indicate power capacity status of the battery unit 31 and correspondingly display light signals of different colors or display light signals in phases). For example, when the electronic device 40 is connected to the power connector 32, the indicator 322 can emit an audio or a light signal to remind users that the electronic device 40 is beginning to charge, and when the charging is complete, the indicator 322 can emit another audio or light signal to indicate that the charging is complete. Notably, the relative placement, shape, or size of the indicator 322 shown in figures of the instant embodiment is only exemplary, which can be modified based on the design intent, and is not limited to the examples provided hereto.

In another embodiment, the power connector 32 can also include a control unit (not shown in figures). The control unit can control the activation, deactivation or relevant operations of the power connector 32. As aforementioned, the instant disclosure provides the passive stylus 1 with a portable power supply which is disposed in a receiving chamber 101 of the conductive body 10 such that both the passive stylus and the portable power supply are incorporated into one housing, which saves space in the passive stylus and provides portable charging.

### Second Embodiment

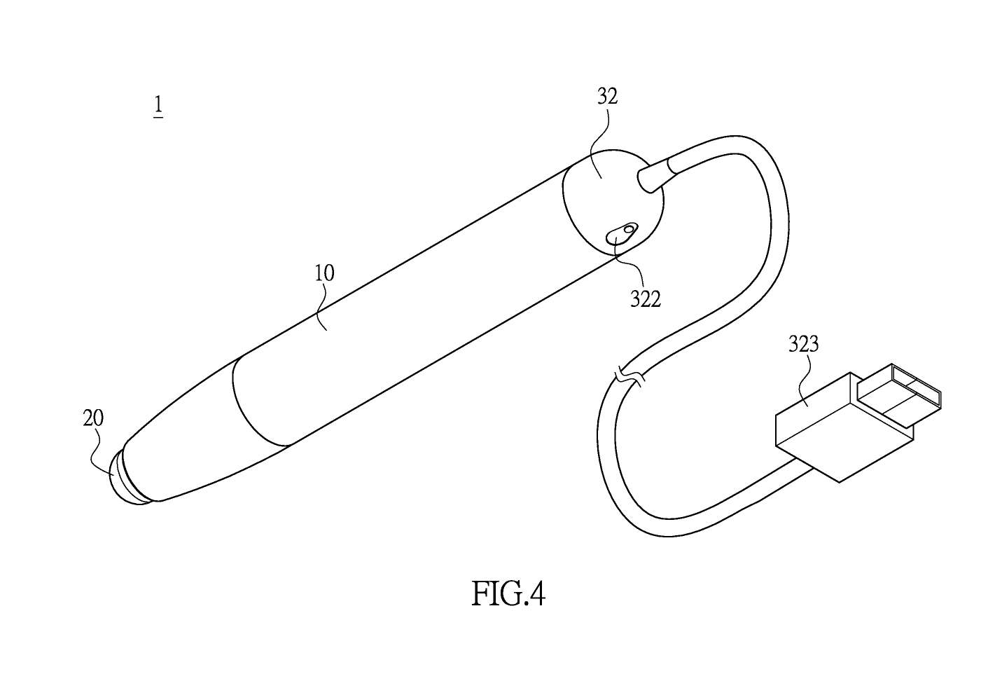

FIG. 4 is a perspective view of the passive stylus in accordance with the second embodiment of the instant disclosure. The assembly and configuration of the components in the instant embodiment are similar to the previous embodiment, which are not further disclosed. In the instant embodiment, the power connector 32 can be a female interface or a male interface. The male interface can be connected to one end of the stylus though a cable. In another example, the male interface can be directly arranged at one end of the stylus 1 which can be coupled to a sliding structure. Thus, when the user desires to use power connector 32 of the male interface, the male interface of the power connector 32 can be pressed, pushed, or pulled. The male interface is then outwardly ejected or extended from the sliding structure. Notably, although the power connector 32 as shown in FIG. 4 is a USB interface but is not limited to only USB type of interface, and can be modified based on design intent. As other types of interfaces are readily appreciated and understood by a person having ordinary skill in the art.

### Third Embodiment

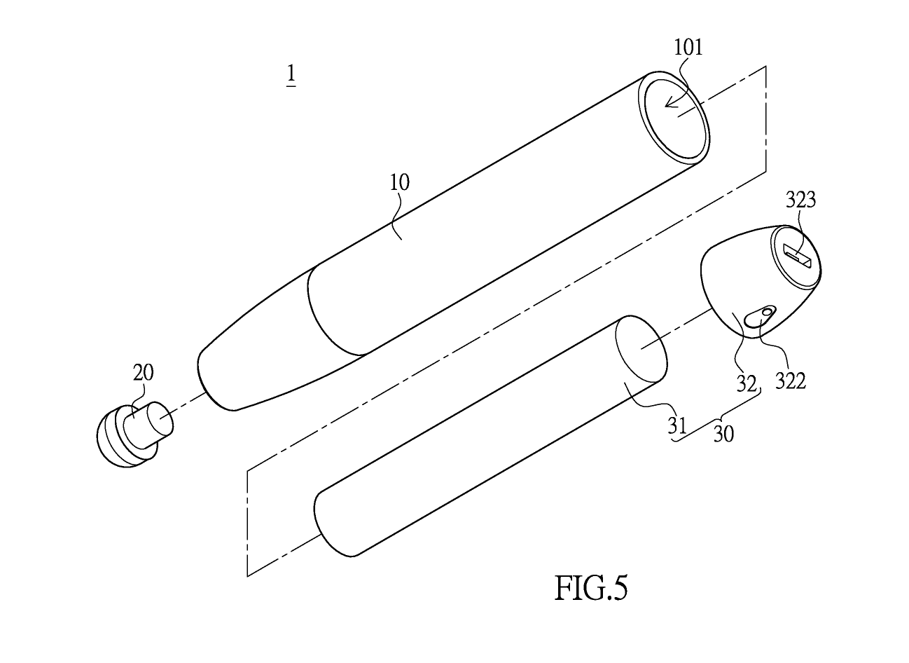

FIG. 5 is an exploded view of the passive stylus in accordance with the third embodiment of the instant disclosure. As shown, the stylus 1 includes a conductive body 10 and a power supply 30. The assembly and configuration of the components in the instant embodiment are similar to the previous embodiment, which are not further disclosed. In the instant disclosure, the touch-control portion 20 can be press-fitted, bolted, coupled or detachably disposed at one end of the conductive body 10.

### Fourth Embodiment

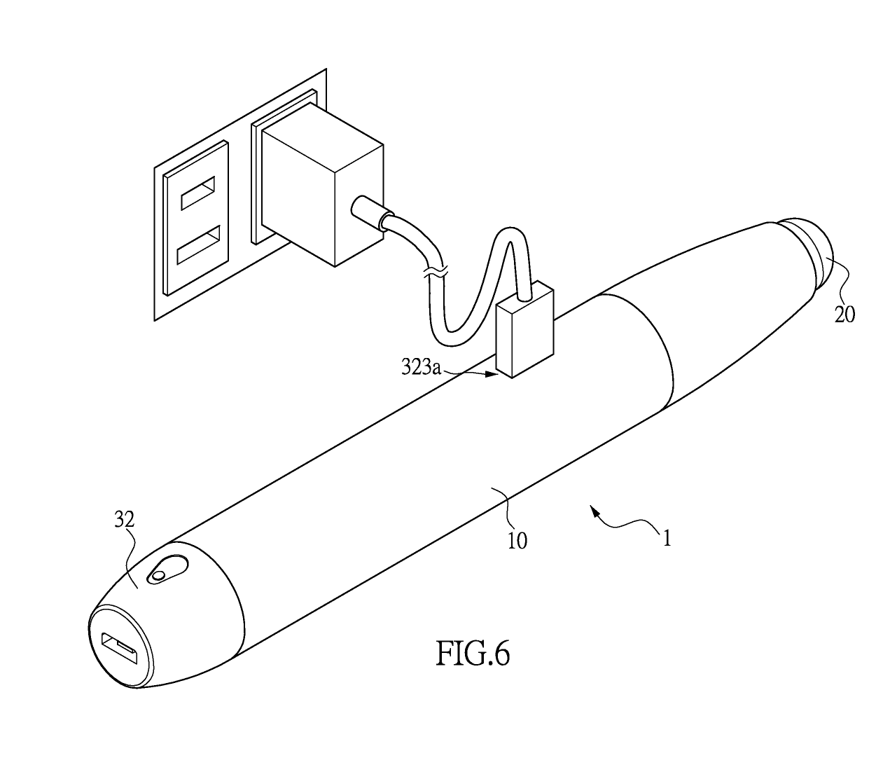

Please refer to FIGS. 3 and 6. FIG. 6 is a perspective view of the passive stylus in accordance with the fourth embodiment of the instant disclosure. Another operational mode is shown in figures. The power connector 32 may include a plurality of USB interfaces or electric connectors, and can be arranged on different portions of the stylus 1 depending on design intent. In the instant embodiment, specifically regarding the example of the stylus with two USB interfaces, but not limited here to (such as the stylus may include only one USB interface. Power supply 30 can charge the electronic device 40 via the USB interface or can charge the battery unit 31 via the electrical connection between the USB interface and the external power supply.)

In one embodiment as shown in FIG. 3, the USB interface 323 having electrical charging functionality is arranged at a tail end of the stylus 1 such that users can operate the stylus 1 while electrically charge the electronic device 40 (the stylus can independently operate or charge). As illustrated in FIG. 6, the USB interface 323a having electrical charging functionality (external power supply is for charging the battery unit 31) is arranged proximate to a head end of the stylus 1.

### Fifth Embodiment

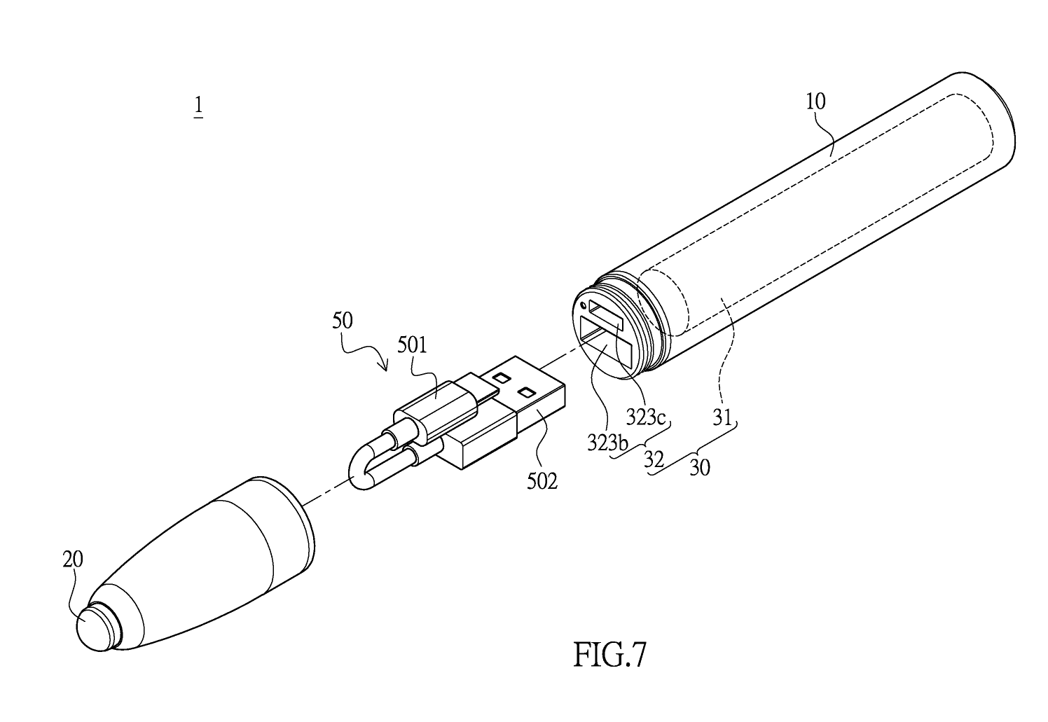

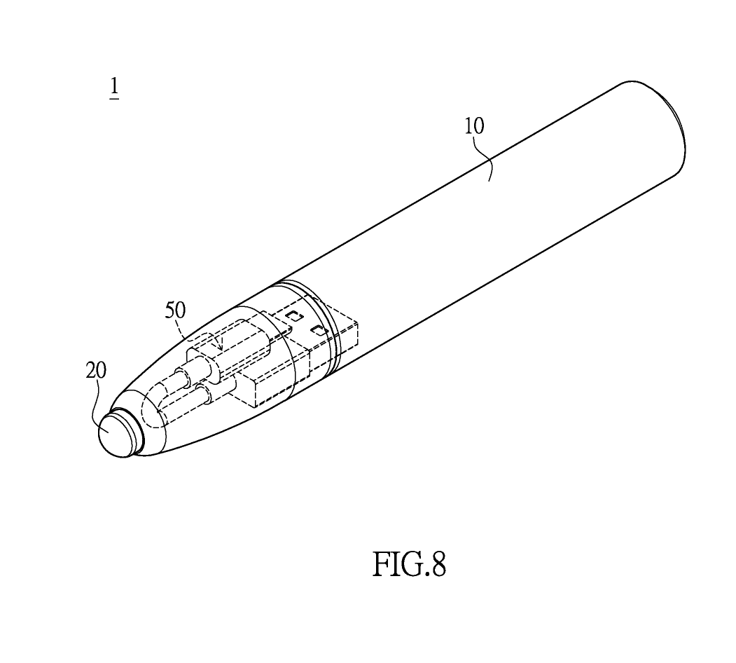

Please refer to FIGS. 7 and 8 as an exploded view and an assembled view of the passive stylus in accordance with a sixth embodiment of the instant disclosure. As shown in figures, the stylus 1 includes the conductive body 10, the touch-control portion 20, and the power supply 30. The relative configurations between each component are similar to previous embodiments, and thus, will not be further discussed. Notably, the touch-control portion 20 may have a shell structure which can be detachably installed on an end of the conductive body 10 such that a connection cable 50 can be stored. In one preferred example, two ends of the connection cable 50 can be different types of USB plugs 501, 502. For example, while one end is a Micro USB plug 501, the other end is a USB A-type plug 502. Relatively, the power supply 30 may have different USB interfaces 323b, 323c (USB A-type, Micro USB). Specifically, the USB plug 501 (Micro USB) is connected to the preferred electronic device for electrical charging, and the USB plug 502 (USB A-type) is inserted into the USB interface 323b (USB A-type) of the power supply 30 such that the battery unit 31 charges the electronic device. In contrast, the USB plug 501 (Micro USB) can be inserted into the USB interface 323c, and the USB plug 502 is connected to external power sources (not shown in figures) such that the battery unit 31 charges the electronic device. The various USB types and combinations as aforementioned are only provided as examples of the instant embodiment, but are not limited thereto. Moreover, the relative configurations of the power supply 30 and the touch-control portion 20 with respect to the conductive body 10 which are shown on figures are not limited thereto. The power supply 30 can also be disposed in the other end of the conductive body 10, and the connection cable 50 can be similarly be stored in the touch-control portion 20.

### Sixth Embodiment

FIG. 7 is an exploded view of the passive stylus in accordance with the fifth embodiment of the instant disclosure. As shown, the stylus 1 includes a conductive body 10, a touch-control portion 20 and a power supply 30. The assembly and configuration of the components in the instant embodiment are similar to the previous embodiment, which are not further disclosed. Notably, the battery unit 31 can be replaceable rechargeable battery. The power connector 32 can be detachably disposed at one end (the end of the conductive body 10 having an opening) of the conductive body 10. Moreover, to accommodate the replaceable rechargeable battery, the inner wall of the conductive body 10 is configured with a conductive element 102 therein to electrically connect at least one battery unit 31. One end of the conductive element 102 can be configured proximate to an end portion of the receiving chamber 101, the other end of the conductive element 102 can be configured proximate to the opening of the conductive body 10. The conductive element 102 can be embedded into the housing of the conductive body 10.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A passive stylus, comprising:
a conductive body having a tubular structure and portions defining a receiving chamber therein, one end of the conductive body having a touch-control portion ; and
a power supply, comprising:
a battery unit disposed in the receiving chamber of the conductive body; and
a power connector electrically connected to the battery unit;
wherein when the power connector is connected to an electronic device, the battery unit electrically charges the electronic device.

2. The passive stylus as recited in claim 1, wherein the power connector is selectively connected to an external power source.

3. The passive stylus as recited in claim 2, wherein the power connector includes at least one universal serial bus electrically connected to the electronic device or the external power source.

4. The passive stylus as recited in claim 2, wherein the power connector includes a control unit controlling the charging and discharging of the battery unit.

5. The passive stylus as recited in claim 2, wherein power connector includes at least one indicator signifying the charging and discharging status of the power supply.

6. The passive stylus as recited in claim 1, wherein the touch-control portion is made of a material selected from the group consisting of conductive gel, conductive foam, conductive polymer, metallic conductive body and the combination thereof.

7. A passive stylus, comprising:
a conductive body having a tubular structure and portions defining a receiving chamber therein;
a touch-control portion arranged at one end of the conductive body, the touch-control portion being a conductive structure and electrically connected to the conductive body; and
a power supply, comprising:
a battery unit disposed in the receiving chamber of the conductive body; and
a power connector electrically connected to the battery unit;
wherein when the power connector is connected to an electronic device, the battery unit electrically charges the electronic device.

8. The passive stylus as recited in claim 7, wherein the power connector is selectively connected to an external power source.

9. The passive stylus as recited in claim 8, wherein the power connector includes at least one universal serial bus electrically connected to the electronic device or the external power source.

10. The passive stylus as recited in claim 9, wherein two USBs are respectively arranged at two ends of the conductive body.

11. The passive stylus as recited in claim 9, wherein two USBs are arranged at one end of the conductive body.

12. The passive stylus as recited in claim 8, wherein the power connector includes a control unit controlling the charging and discharging of the battery unit.

13. The passive stylus as recited in claim 8, wherein the power connector includes at least one indicator signifying the charging and discharging status of the power supply.

14. The passive stylus as recited in claim 7, wherein the touch-control portion has a shell structure and is detachably arranged at one end of the conductive body.

15. A passive stylus, comprising:
a conductive body having a tubular structure and portions defining a receiving chamber therein,
a conductive element disposed in the receiving chamber;
a touch-control portion arranged at one end of the conductive body, the touch-control portion being a conductive structure and electrically connected to the conductive body; and
a power supply, comprising:
at least one battery unit disposed in the receiving chamber of the conductive body, one end of the battery unit electrically connected to one end of the conductive element; and
a power connector electrically connected to the other end of the conductive element and the other end of the battery unit;
wherein when the power connector is connected to an electronic device, the battery unit electrically charges the electronic device.

16. The passive stylus as recited in claim 15, wherein the power connector is selectively connected to an external power source.

17. The passive stylus as recited in claim 16, wherein the power connector includes at least one universal serial bus electrically connected to the electronic device or the external power source.

18. The passive stylus as recited in claim 16, wherein the power connector includes a control unit controlling the charging and discharging of the battery unit.

19. The passive stylus as recited in claim 16, wherein two USBs are respectively arranged at two ends of the conductive body.

20. The passive stylus as recited in claim 16, wherein the power connector includes at least one indicator signifying the charging and discharging status of the power supply.

21. The passive stylus as recited in claim 15, wherein the touch-control portion is made of a material selected from the group consisting of conductive gel, conductive foam, conductive polymer, metallic body and the combination thereof.

22. The passive stylus as recited in claim 15, wherein the at least one battery unit is a rechargeable battery.

23. The passive stylus as recited in claim 15, wherein the touch-control portion is detachably arranged at one end of the conductive body.

24. The passive stylus as recited in claim 15, wherein the power connector is detachably arranged at one end of the conductive body.
